(19) United States
(12) Patent Application Publication
(10) Pub. No.: US 2019/0048656 A1
(43) Pub. Date: Feb. 14, 2019

(54) Solar-powered Blinds System and Apparatus

(71) Applicant: JOHN COMBEE, Waynesville, NC (US)

(72) Inventor: JOHN COMBEE, Waynesville, NC (US)

(21) Appl. No.: 16/101,214

(22) Filed: Aug. 10, 2018

Related U.S. Application Data
(60) Provisional application No. 62/543,956, filed on Aug. 10, 2017.

(51) Int. Cl. E06B 9/38; H02S 20/30; H02S 30/20; E06B 9/68; F24S 20/63

(52) U.S. Cl. CPC E06B 9/38; H02S 20/30; H02S 30/20; E06B 2009/2476; F24S 20/63; E05Y 2900/148; E06B 9/68

(57) ABSTRACT

A window covering solution equipped with solar panels is described. The solution amounts to linear slats, namely blinds, on which solar panels are disposed. The panels are configured to capture PV power and store it within at least one power cell composed of rechargeable batteries. The power is stored for later use to charge devices via one or more USB ports disposed at a bottom of the apparatus. LED lights are disposed within the apparatus, which are powered via solar power supplied from the solar panels disposed on the blinds. A smoke detector and security alarm, also indirectly powered via the solar panels, are preferably disposed within the apparatus.

### CONTINUITY

This application is a non-provisional patent application of provisional patent application No. 62/543,956, filed on Aug. 10, 2017, and priority is claimed thereto.

### FIELD OF THE PRESENT INVENTION

The present invention relates to the field of window covering systems, and more specifically relates to a window covering solution configured to power integrated LED lights and provide a USB-based device charging solution via solar panels disposed on blinds.

### BACKGROUND OF THE PRESENT INVENTION

Window coverings are a common necessity for most domiciles and businesses. Conventionally, blinds, shades, drapes, or curtains are employed to provide privacy, insulation, and to block out sunlight during the heat of the day. Such window coverings are traditionally disposed on the inside of windows of the home, office, apartment, etc. One of the most common forms of window coverings employed are blinds, which are generally horizontal or vertical slats configured to open or close at the will of a user. Usually the blinds are composed of wood, vinyl, metal, or other conventional material, and are static in coloration, texture, and pattern on both sides of the blinds. However, the utility of such window covering systems such as conventional blinds is limited to blocking a window, and nothing more.

As one side of the blinds is almost always directed towards the sun during daylight hours, it stands to reason that the exterior of blinds represents an ideal placement for solar panels. Many households have a desire to use renewable, sustainable power such as solar power to (at the minimum) augment the power supply to the home. However, the cost of roof-mounted panels often prohibits many homeowners from investing in renewable energy. If there were a way in which blinds could be equipped with solar panels, power could be effortlessly captured and stored for later use within the home or office. Such a system would present the average homeowner a way in which he or she may capture useful energy from the sun to augment power for lighting in the home and charging portable electronics.

Thus, there is a need for a system of solar powered blinds configured to capture and store photovoltaic power of the sun for household use. Such a system and apparatus is preferably equipped with several solar panels disposed on an outside of vertical or horizontal blinds such that the solar panels are exposed to the sun during the day. The power is preferably stored within internal rechargeable batteries, at which point the power may be employed to charge a variety of consumer electronics via at least one USB port.

### SUMMARY OF THE PRESENT INVENTION

The present invention is a solar-powered retractable window blind system configured to provide power to lights and portable electronics via an integrated solar panel system. The blinds are equipped with solar panels disposed on a first side of the blinds such that they are oriented towards the sun when the blinds are closed. The solar panels are configured to recharge batteries housed within a battery compartment disposed within a ballast of the blinds. Power stored within the batteries is reserved for use by a user to charge portable electronics via at least one USB port, as well as to illuminate at least one LED bulb disposed on the ballast and/or blinds. One or more photos may be configured to be displayed on a second side of the blinds, facing the interior of the structure to enhance the aesthetic appeal of the apparatus.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the front of the apparatus of the present invention.

FIG. 2 exhibits a flow chart detailing the process of use of the apparatus of the present invention.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

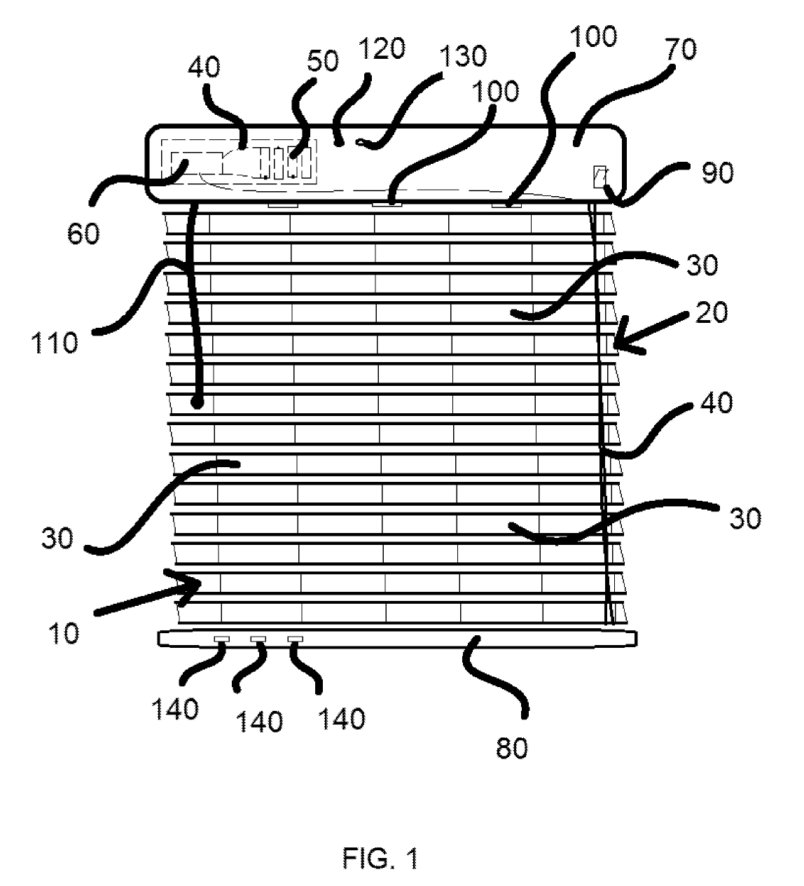

The present invention is a solar-powered window covering solution apparatus. As disclosed in FIG. 1, the apparatus is equipped with blinds (10) disposed in a horizontal or vertical orientation. The blinds are equipped with a first side (20) and a second side (not shown). The first side (20) of the blinds (10) is equipped with solar panels (30), which are oriented towards the window at which the present invention is installed to cover when in use, facing the sun during the day. Additionally, the preferred embodiment of the present invention is equipped with at least one battery (50), at least one wire (40) connecting the at least one battery (50) to a solar charge controller (60) and to the solar panels (30).

The blinds (10) of the present invention preferably extend between a top ballast (70) and a bottom ballast (80) (or alternately, a right ballast and a left ballast in installations employing horizontal blinds). The top ballast (70) includes a housing, which preferably contains the at least one battery (50) and solar charge controller (60). A switch (90) is preferably present, disposed either on the top ballast (70) or bottom ballast (80), which is preferably configured to manually activate at least one LED bulb (100), which are disposed within the top ballast (70) and/or within the blinds (10) themselves. The at least one LED bulb (100) is in communication with the at least one battery (50) and the switch (90) via at least one wire (40). The at least one LED bulb (100) is oriented such that is casts light towards the interior of the structure, away from the window, helping to illuminate the room at night. An ambient light sensor may be disposed within the top ballast (70) or bottom ballast (80) to facilitate automatic activation of the at least one LED bulb (100) upon nightfall. Power of the at least one battery (50), charged via the at least one solar panel (30), is also provided to at least one USB port (140) preferably disposed within the bottom ballast (80) to enable the user to charge portable electronics such as cellular phones, tablets, controllers, gaming systems, etc.

Per convention, the blinds (10) of the present invention are similarly equipped with a pull cord (110) configured to facilitate the manipulation of the blinds (10) into a raised or lowered position per the will of an end user. Alternately, some embodiments of the present invention may be equipped with an electric motor configured to manipulate the height (or namely, the extent to which the window is covered by the blinds (10)) without necessitating use of the pull cord (110). In such instances, the electric motor is preferably powered via the at least one battery (50).

Additionally, preferred embodiments of the present invention are equipped with a smoke detector (120) and alarm system (130). The alarm system (130) preferably includes a speaker, which is configured to sound an alert when smoke is detected, as well as if a likely break-in is detected via abnormal movement of the blinds (10). The alarm system (130) and smoke detector (120) are preferably housed within the top ballast (70) as shown in FIG. 1.

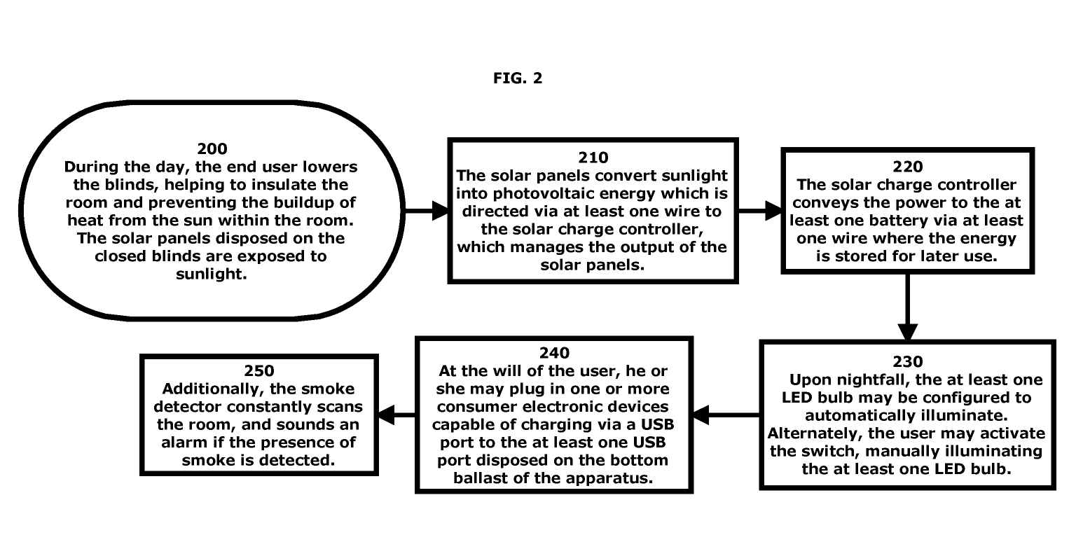

The process of use of the system and apparatus of the present invention, as depicted in FIG. 2, is preferably as follows:

1. During the day, the end user lowers the blinds, helping to insulate the room and preventing the buildup of heat from the sun within the room. The solar panels disposed on the closed blinds are exposed to sunlight. (200)

2. The solar panels convert sunlight into photovoltaic energy which is directed via at least one wire to the solar charge controller, which manages the output of the solar panels. (210)

3. The solar charge controller conveys the power to the at least one battery via at least one wire where the energy is stored for later use. (220) When the at least one battery is detected to be full by the solar charge controller, the solar charge controller prevents over-charging of the at least one battery.

4. Upon nightfall, the at least one LED bulb may be configured to automatically illuminate. Alternately, the user may activate the switch, manually illuminating the at least one LED bulb. (230) The at least one LED bulb is illuminated via power stored within the batteries originating from photovoltaic power of the solar panels.

5. At the will of the user, he or she may plug in one or more consumer electronic devices capable of charging via a USB port to the at least one USB port disposed on the bottom ballast of the apparatus. (240)

6. Additionally, the smoke detector constantly scans the room, and sounds an alarm if the presence of smoke is detected. (250)

In some alternate embodiments of the present invention, a camera and/or motion detection sensor may be added to the apparatus. In such embodiments, the motion detector may be configured to detect motion, either of the blinds (10) themselves, or oriented towards the room as a security feature. The camera may be configured to begin capturing images and/or video upon activation via the motion detector. The motion detector aides the alarm system (130) such that, when abnormal motion of the blinds (10) is detected, the alarm system (130) sounds an alarm through the speaker. It should be understood that the alarm system (130), speaker, and smoke detector (120) are powered via the at least one battery (50).

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A window covering system comprising:
blinds, said blinds having a first side and a second side;
a top ballast;
a bottom ballast;
wherein said blinds extend between said top ballast and said bottom ballast;
at least one solar panel, said at least one solar panel disposed on said second side of said blinds;
at least one wire, said at least one wire configured to convey photovoltaic power of said at least one solar panel to at least one battery via a solar charge controller;
at least one LED bulb, said at least one LED bulb in communication with said at least one battery via at least one wire;
at least one USB port, said at least one USB port in communication with said at least one battery via at least one wire; and
wherein said at least one solar panel is configured to charge said at least one battery.

2. The system of claim 1, further comprising:
an alarm system, said alarm system in communication with said at least one battery.

3. The system of claim 1, wherein said solar charge controller and said at least one battery are housed within said top ballast.

4. The system of claim 1, wherein said at least one USB port is housed within said bottom ballast.

5. The system of claim 1, further comprising:
a smoke detector, said smoke detector housed within said top ballast; and
wherein said smoke detector is in communication with said at least one battery.
